(19) United States
(12) Patent Application Publication
(10) Pub. No.: US 2011/0057905 A1
(43) Pub. Date: Mar. 10, 2011

(54) Touch Panel and Inspection Method Thereof

(76) Inventors: Hong-Chih Yu, Shen-zhen (CN); Lung-Chuan Chang, Shen-zhen (CN)

(21) Appl. No.: 12/869,713

(22) Filed: Aug. 26, 2010

Related U.S. Application Data
(63) Continuation of application No. PCT/CN2009/075756, filed on Dec. 21, 2009.

(30) Foreign Application Priority Data
Sep. 4, 2009 (CN) 200910189876.4

(51) Int. Cl. G06F 3/045

(52) U.S. Cl. 345/174

(57) ABSTRACT

The present invention provides a touch panel, including a substrate, a plurality of first sensing lines, a plurality of second sensing lines and an insulation layer. The first sensing lines are disposed on the substrate. Each first sensing line extends along a first direction and at least one end of each first sensing line includes a first inspecting region. The second sensing lines are disposed on the substrate. At least one end of each second sensing line includes a second inspecting region and each second sensing line extends along a second direction. The first direction is not parallel to the second direction. The insulation layer covers the first sensing lines and the second sensing lines and exposes the first inspecting regions and the second inspecting regions. The present invention further provides an inspection method of a touch panel.

### CROSS REFERENCE TO RELATED APPLICATIONS

This application is a continuation of International Application No. PCT/CN2009/075756 filed on Dec. 21, 2009.

### BACKGROUND OF THE INVENTION

1. Field of the Invention

The present invention relates to a touch panel and an inspection method thereof, more particularly, to a touch panel with sensing lines that can be inspected separately and an inspection method thereof.

2. Description of the Prior Art

Along with the development of technology, notebooks, mobile phones, portable media players and other electronic devices are gradually utilizing touch panels to replace traditional keyboards as a new generation of an input interface. Conventional touch panels can be divided into capacitive touch panels and resistive touch panels. Due to the multi-touch function, the capacitive touch panels are receiving much attention.

In general, the capacitive touch panel includes a plurality of sensing lines formed on the surface of the substrate. When a user uses its finger or a conductive object to approach or touch the surface of the capacitive touch panel, the capacitance value of the sensing lines will change correspondingly. The touch location on the touch panel can therefore be sensed and calculated by sensing the change of the capacitance value. It is known that the sensing accuracy of the capacitive touch panel depends largely on the electrical characteristics of each sensing line. Therefore, if there are open circuits, short circuits or the phenomenon of uneven capacitance effects in the sensing lines, the touch sensing accuracy will be affected. Accordingly, the inspection of the sensing lines becomes very important.

Chinese patent application publication number CN101408825 disclosed a method of inspecting a semi-finished product of a touch panel. However, the inspection method in this patent requires additional inspecting lines on the semi-finished product of the touch panel, therefore decreasing the utilization efficiency of the substrate. Moreover, the inspection method inspects the sensing lines together with the corresponding connecting wires, but it is unable to inspect the electrical characteristics of the sensing lines individually. Chinese patent number CN100498483 disclosed a method of inspecting the terminal parts of an active matrix substrate. However, the inspection method can not inspect the sensing lines individually when applied to the capacitive touch panels. In short, the above-mentioned patents are unable to detect the defects of the sensing lines precisely, and are prone to be affected by the interference of high resistance RC effect of the connecting wires, which might affect the actual capacitance measurements. And due to the large deviation of the measurements, pseudo-defects can easily occur in the subsequent inspecting processes. Consequently, effectively inspecting the sensing lines of the capacitive touch panels to maintain the quality of capacitive touch panels remains an important issue in this field.

### SUMMARY OF THE INVENTION

The present invention provides a touch panel, wherein an inspecting region exposed by an insulation layer is provided on the end of the sensing lines for inspection.

The present invention provides an inspection method which is able to precisely detect the capacitance value and the resistance value of the sensing lines.

The present invention provides an inspection method which is able to detect the resistance value of the connecting wires precisely.

The present invention provides a touch panel, including a substrate, a plurality of first sensing lines, a plurality of first connecting wires corresponding to the first sensing lines, a plurality of second sensing lines, a plurality of second connecting wires corresponding to the second sensing lines, and an insulation layer. The first sensing lines are disposed on the substrate. Each first sensing line extends along a first direction and at least one end of each first sensing line includes a first inspecting region. The second sensing lines are disposed on the substrate. At least one end of each second sensing line includes a second inspecting region and each second sensing line extends along a second direction. The first direction is not parallel to the second direction. The insulation layer covers the first sensing lines and the second sensing lines and exposes the first inspecting regions and the second inspecting regions.

In one embodiment of the present invention, the above mentioned insulation layer includes a plurality of openings. The openings expose the first inspecting regions and the second inspecting regions correspondingly.

In one embodiment of the present invention, each above mentioned first sensing line and each above mentioned second sensing line are formed by a plurality of sensing pads and a plurality of bridge parts. The sensing pads include a plurality of center sensing pads and two peripheral sensing pads. The center sensing pads are connected to each other by the bridge parts and are disposed between the two peripheral pads. The first inspecting region or the second inspecting region is disposed in the peripheral sensing pads. The substrate includes a display region and a non-display region, and each peripheral sensing pad includes an outer part and an inner part. The outer part is disposed in the non-display region while the inner part and the center sensing pads are disposed in the display region. In addition, the first inspecting region or the second inspecting region is in the outer part.

In one embodiment of the present invention, the above mentioned substrate includes a first sensing region and a second sensing region. A portion of the first sensing lines and a portion of the second sensing lines are disposed in the first sensing region. Other portions of the first sensing lines and other portions of the second sensing lines are disposed in the second sensing region. The second sensing lines in the first sensing region are aligned with the second sensing lines in the second sensing region.

In one embodiment of the present invention, the above mentioned first sensing lines are disposed on a first side of the substrate and the second sensing lines are disposed on a second side of the substrate. The first side and the second side are disposed opposite to each other. In one embodiment, each first sensing line is formed by a sensing bar and each second sensing line is formed by a sensing bar. Moreover, the touch panel further includes a plurality of dummy pads disposed on the first side of the substrate and between each of the first sensing lines. Specifically, the insulation layer includes a first insulation layer and a second insulation layer. The first insulation layer covers the first sensing lines and exposes the first inspecting regions. The second insulation layer covers the second sensing lines and exposes the second inspecting regions. The first insulation layer, for example, includes a plurality of first openings to expose the first inspecting regions, and the second insulation layer, for example, includes a plurality of second openings to expose the second inspecting regions.

In one embodiment of the present invention, the above mentioned touch panel further includes a plurality of first connecting wires and a plurality of second connecting wires. A first connecting terminal of each first connecting wire connects to one of the first sensing lines, and a second connecting terminal of each second connecting wire connects to one of the second sensing lines. The insulation layer further covers the first connecting wires and the second connecting wires. Besides, the insulation layer further exposes a signal terminal of each first connecting wire and a second signal terminal of each second connecting wire.

The present invention further provides an inspection method of a touch panel. The inspection method includes providing the above mentioned touch panel and performing an inspecting process to inspect two inspecting regions of the groups consisting of the first inspecting regions and/or the second inspecting regions.

In one embodiment of the present invention, the above mentioned inspecting process further includes inspecting one of the first inspecting regions and one of the second inspecting regions.

In one embodiment of the present invention, both ends of each first sensing line include the first inspecting regions. The inspecting process includes inspecting the two first inspecting regions on two ends of the same first sensing line.

In one embodiment of the present invention, both ends of each second sensing line include the second inspecting regions. The inspecting process includes inspecting the two second inspecting regions on two ends of the same second sensing line.

The present invention further provides an inspection method of a touch panel. The inspection method includes providing the above mentioned touch panel, then performing an inspecting process to inspect one of the first inspecting regions and the corresponding first signal terminal, or to inspect one of the second inspecting regions and the corresponding second signal terminal.

In light of above, the inspecting regions in the present invention are disposed on the ends of the sensing lines in the touch panel in the present invention, and the insulation layer exposes the inspecting regions. Therefore, in the touch panel of the present invention, the sensing lines can be inspected individually, and the defects of the sensing lines can be detected more accurately without being interfered with by high-resistance RC properties of the connecting wires, which might affect the actual capacitance measurements. In addition, in the touch panel of the present invention, the connecting wires can also be inspected individually to more accurately detect the defects of the touch panel. With the above mentioned touch panel structure, the inspection method of the present invention can more efficiently detect the defects of the sensing lines and the connecting wires.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a top view of the first embodiment of the touch panel in the present invention.

FIG. 2 is a schematic diagram of the region I in FIG. 1.

FIG. 3 is a schematic diagram showing a cross-sectional view along the AA′ line in FIG. 2.

FIG. 4 is a schematic diagram showing a top view of the second embodiment of the touch panel in the present invention.

FIG. 5 is a schematic diagram of region II in FIG. 4.

FIG. 6 is a schematic diagram showing a cross-sectional view along the BB′ line in FIG. 5

FIG. 7 is a schematic diagram showing a top view of the third embodiment of the touch panel in the present invention.

FIG. 8 is a schematic diagram showing a top view of the fourth embodiment of the touch panel in the present invention.

FIG. 9 is a schematic diagram showing a cross-sectional view of the fifth embodiment of the touch panel in the present invention.

FIG. 10 is a schematic diagram showing a top view of the first side of the touch panel.

FIG. 11 is a schematic diagram showing a top view of the second side of the touch panel.

FIG. 12 shows a first inspection method of one embodiment of the touch panel in the present invention.

FIG. 13 shows a second inspection method of one embodiment of the touch panel in the present invention.

FIG. 14 shows a third inspection method of one embodiment of the touch panel in the present invention.

### DETAILED DESCRIPTION

To provide a better understanding of the presented invention, preferred embodiments will be described in detail. The preferred embodiments of the present invention are shown in the accompanying drawings with numbered elements.

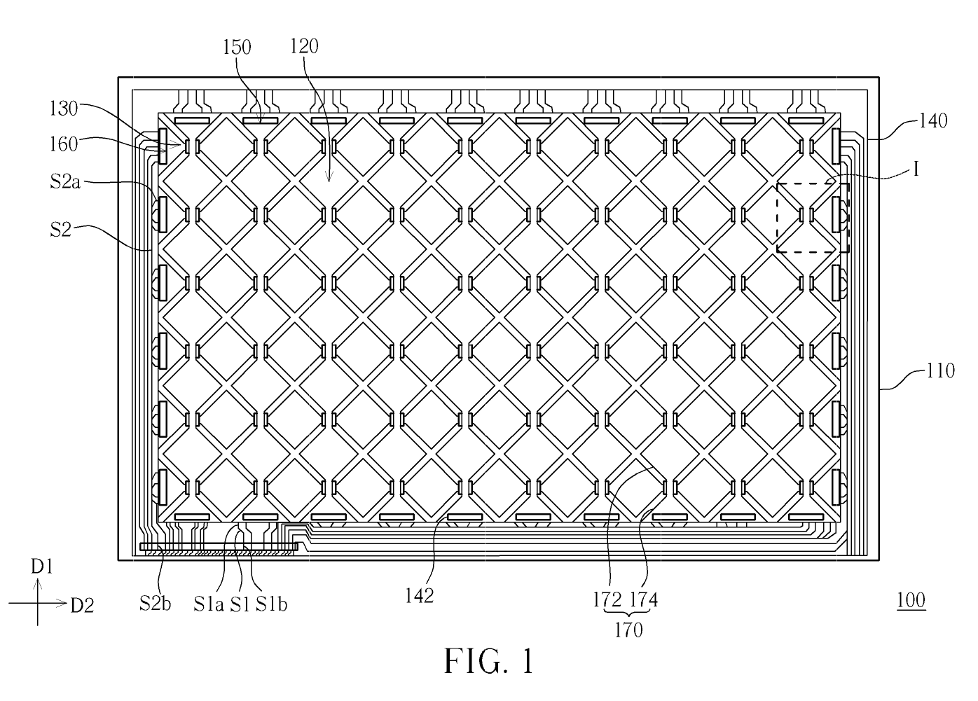

FIG. 1 is a schematic diagram showing a top view of the first embodiment of the touch panel in the present invention. Please refer to FIG. 1. The touch panel 100 includes a substrate 110, a plurality of first sensing lines 120, a plurality of second sensing lines 130 and an insulation layer 140. The first sensing lines 120 and the second sensing lines are both disposed on the substrate 110. Each first sensing line 120 extends along a first direction D1, and each second sensing line 130 extends along a second direction D2. The first direction D1 is not parallel to the second direction D2. The first sensing lines 120 can be perpendicular to the second sensing lines 130. In addition, at least one end of each first sensing line 120 includes a first inspecting region 150, and at least one end of each second sensing line 130 includes a second inspecting region 160. The insulation layer 140 covers the first sensing lines 120 and the second sensing lines 130 and exposes the first inspecting regions 150 and the second inspecting regions 160.

In the present embodiment, both ends of each first sensing line 120 include the first inspecting regions 150 while both ends of each second sensing line 130 include the second inspecting regions 160. In another embodiment, only one end of each first sensing line 120 includes the first inspecting region 150 while only one end of each second sensing line 130 includes the second inspecting region 160. In addition, the insulation layer 140 in the present embodiment includes a plurality of openings 142. The shape of openings 142 can be round, oval, rectangular, polygonal, or other varieties of closed shapes formed by curves. Each opening 142 exposes one first inspecting region 150 or exposes one second inspecting region 160.

Moreover, the touch panel 100 further includes a plurality of first connecting wires S1 and a plurality of second connecting wires S2. A first connecting terminal S1a of each first connecting wire S1 connects to one of the first sensing lines 120, and a second connecting terminal 52a of each second connecting wire S2 connects to one of the second sensing lines 130. The other end of each first connecting wire S1 is a first signal terminal S1b and the other end of each second connecting wire S2 is a second signal terminal 52b. The above mentioned connecting wires are integrated into a side of the non-display region of the substrate no by arranging the layout of the connecting wires. All the signal terminals of the connecting wires are connected to a driving chip (not shown).

In the present embodiment, the insulation layer 140 further covers the first connecting wires S1 and the second connecting wires S2. Besides, the insulation layer 140 further exposes each first signal terminal S1b and each second signal terminal 52b. In other words, a portion of the openings 142 of the insulating layer 140 are disposed on the first signal terminals S1b and the second signal terminals 52b in order to expose the first signal terminals S1b and the second signal terminals 52b.

In such a design, when inspecting the touch panel 100, the sensing lines 120, 130 and the connecting wires S1, S2 can be inspected separately. In other words, when inspecting the sensing lines 120, 130, the inspecting results will not be affected by the defects of the connecting wires S1, S2. Similarly, when inspecting the connecting wires S1, S2, the inspecting results will not be affected by the defects of sensing lines 120, 130. Therefore, the present embodiment can detect the defects of different components in the touch panel 100 more efficiently, and can improve the quality of touch panel 100.

In detail, each first sensing line 120 and each second sensing line 130 in the present embodiment are formed by a plurality of sensing pads 170 and a plurality of bridge parts (not shown in FIG. 1). The sensing pads 170 include a plurality of center sensing pads 172 and two peripheral sensing pads 174. The center sensing pads 172 are connected to each other and are disposed between the two peripheral pads 174. The first inspecting region 150 or the second inspecting region 160 is disposed in the two peripheral sensing pads 174. That is, both ends of the first sensing lines 120 and both ends of the second sensing lines 130 are composed of the peripheral sensing pads 174.

In the present embodiment, the size of the first inspecting region 150 and the second inspecting region 160 can be determined by the design of the peripheral sensing pads 174. In general, if the peripheral sensing pads 174 have enough large areas, the inspecting process for alignment may be easier. That is, the inspection of the touch panel 100 does not require high-precision alignment equipment and the inspection method can be simplified and speedier.

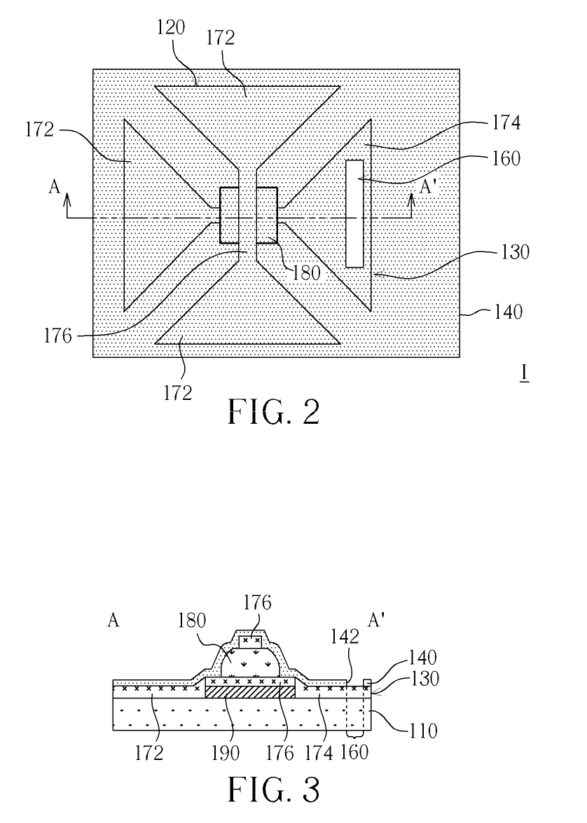

FIG. 2 is a schematic diagram of the region I in FIG. 1, and FIG. 3 is a schematic diagram showing a cross-sectional view along the A-A′ line in FIG. 2. Please refer to FIG. 2 and FIG. 3. In the present embodiment, the adjacent center sensing pads 172 can be connected by a bridge part 176. Certainly, the center sensing pad 172 and the peripheral sensing pad 174 can also be connected by the bridge part 176.

In addition, as shown in FIG. 3, the peripheral sensing pad 174 and the center sensing pad 172 can be further connected by the bridge part 176. However, according to different requirements, it is available to only connect the peripheral sensing pad 174 and the center sensing pad 172 in the second sensing lines 130, or only connect the plurality of center sensing pads 172. It is worth noting that the first sensing lines 120 and the second sensing lines 130 should be insulated from one another. Accordingly, an insulation component 180 is disposed between the bridge part 176 of the first sensing line 120 and the bridge part 176 of the second sensing line 130.

The insulation layer 140 in the present embodiment exposes the first inspecting regions 150, the second inspecting regions 160, the first signal terminals S1b and the second signal terminals 52b. Therefore, an inspection of the electrical characteristics of the touch panel 100 can be carried out by using the regions exposed by the insulation layer 140. In this way, the sensing lines 120, 130 and the connecting wires S1, S2 can be inspected separately. In addition, the inspection method of the touch panel 100 is quite simple, and once the defects are detected, it can be repaired in time. Therefore, the touch panel 100 can have good quality.

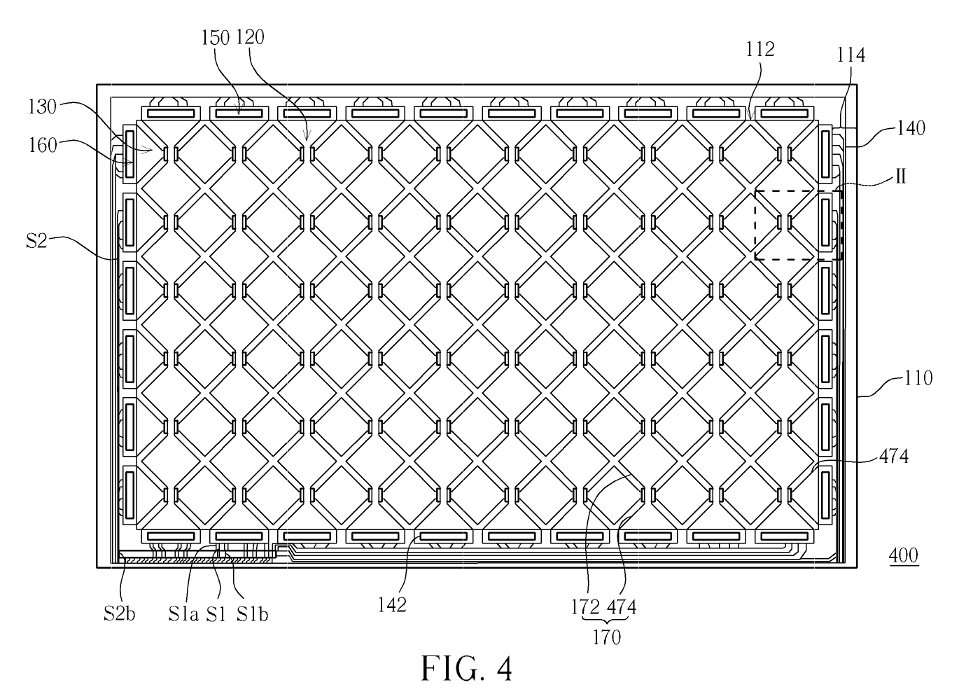

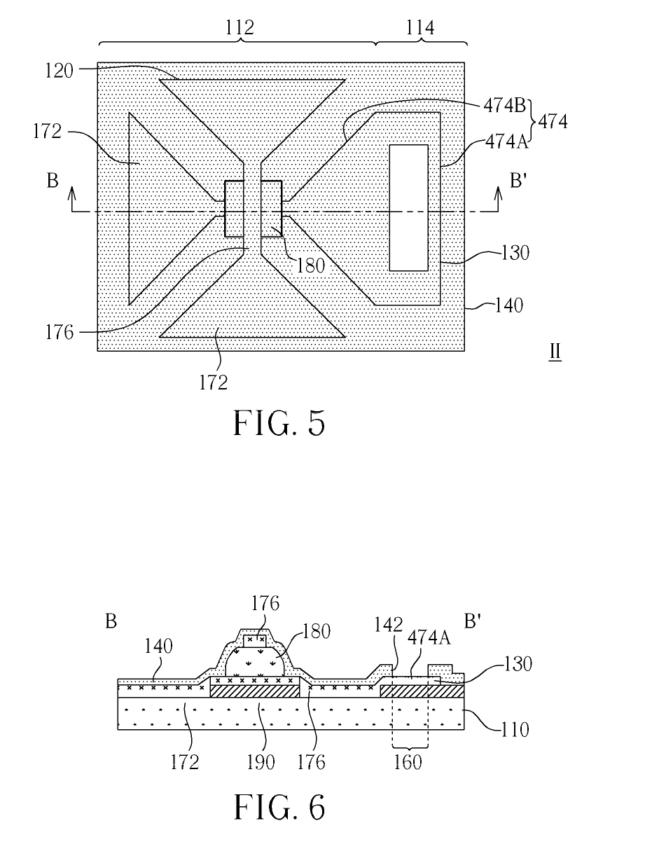

FIG. 4 is a schematic diagram showing a top view of the second embodiment of the touch panel 400 in the present invention. FIG. 5 is a schematic diagram of region II in FIG. 4, while FIG. 6 is a schematic diagram showing a cross-sectional view along B-B′ line in FIG. 5. Please refer to FIG. 4, FIG. 5 and FIG. 6. The touch panel 400 is similar to the touch panel 100 in the first embodiment. The touch panel 400 also includes a substrate 110, a plurality of first sensing lines 120, a plurality of second sensing lines 130, and an insulation layer 140. However, in the touch panel 400, the substrate 110 includes a display region 112 and a non-display region 114. In addition, the peripheral sensing pad 474 includes an outer part 474A and an inner part 474B. The outer part 474A is located in the non-display region 114, while the inner part 474B and the center sensing pads 172 are located in the display region 112. Moreover, the first inspecting region 150 and the second inspecting region 160 are located in the outer part 474A.

Generally speaking, the center sensing pads 172 and the peripheral sensing pads 174 are made by transparent conductive material so as to provide good light transmission for the touch panel 400. When inspecting the touch panel 400, a probe is used by the operator to contact the first inspecting region 150 or the second inspecting region 160 for inspection. However, the movement and contact of the probe may cause damage to the transparent conductive material and thus affect the surface flatness of the first inspecting regions 150 or the second inspecting regions 160. As such, the first inspecting regions 150 and the second inspecting regions 160 in the present embodiment are disposed in the non-display region 114 so as to avoid the light transmittance of the display region 112 being affected. That is, the touch panel 400 not only has good electrical characteristics but also has good light transmittance.

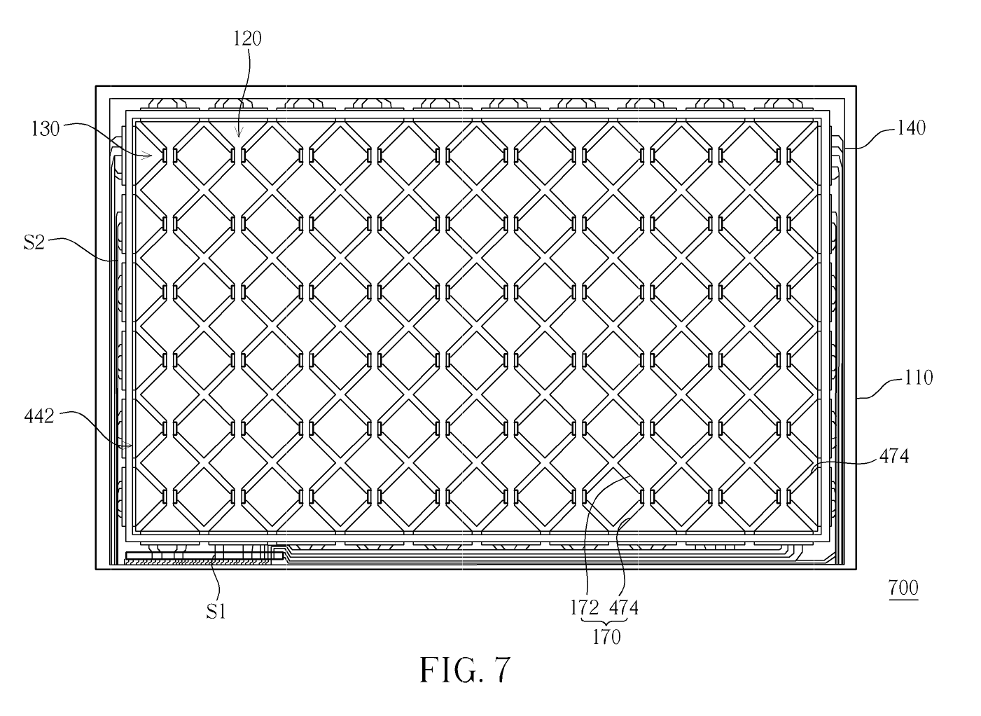

FIG. 7 is a schematic diagram showing a top view of the third embodiment of the touch panel in the present invention. Please refer to FIG. 7. The touch panel 700 modifies the insulation layer 140 in the touch panel 400 to form a circular opening 442. The circular opening 442 exposes all of the first inspecting regions 150 and all of the second inspecting regions 160. In other words, the circular opening 442 is designed to link together all the openings 142 in the second embodiment.

However, in another embodiment, it is also available to link a potion of the openings 142 of the insulation layer 140 and to expose a portion of the first inspecting regions 150 or a portion of the second inspecting regions 160 through the linked openings. The first inspecting regions 150 and the second inspecting regions 160 in the present embodiment are exposed such that the defects of the first sensing lines 120 and the second sensing lines 130 can be detected when inspecting the touch panel 700. The touch panel 700 therefore has good quality.

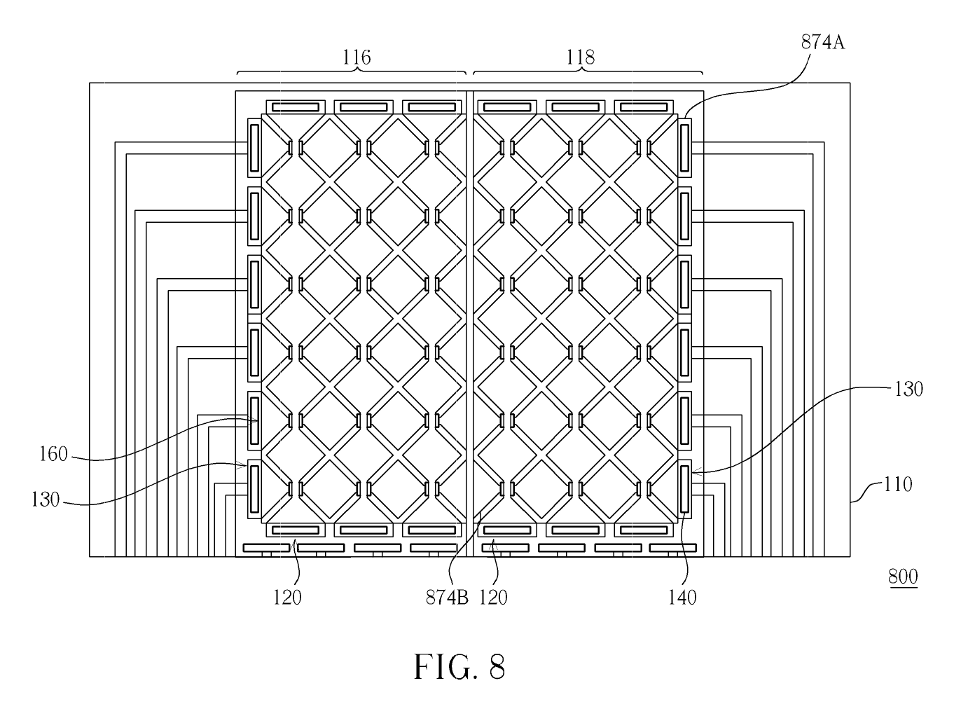

FIG. 8 is a schematic diagram showing a top view of the fourth embodiment of the touch panel in the present invention. Please refer to FIG. 8. The touch panel 800 also includes a substrate 110, a plurality of first sensing lines 120, a plurality of second sensing lines 130 and an insulation layer 140. However, in the present embodiment, the substrate 110 includes a first sensing area 116 and a second sensing area 118. A portion of the first sensing lines 120 and a portion of the second sensing lines 130 are disposed in the first sensing area 116, while the other portion of the first sensing lines 120 and the other portion of the second sensing lines 130 are disposed in the second sensing area 118. Besides, the second sensing lines 130 in the first sensing area 116 are aligned with the second sensing lines 130 in the second sensing area 118. That is, one of the second sensing lines 130 in the first sensing region 116 and one of the second sensing lines 130 in the second sensing region 118 are arranged in a straight line.

According to the configuration in the present embodiment, two second sensing lines 130 are aligned such that the sensor error such as ghost point phenomenon can be avoided when touching the touch panel 800. Moreover, the peripheral sensing pad 874A has similar structure with the peripheral sensing pad 474 in the second embodiment, which is formed by the inner part 474A and the outer part 474B. The peripheral sensing pad 874B, for example, has a triangular pattern. It is worth noting that the second inspecting region 160 is disposed on only one end of the second sensing line 130 in the present embodiment, while there is no inspecting region disposed on center of the display region. In other words, there is no inspecting region disposed in the peripheral sensing pad 874B. Such a design helps improve light transmission of the touch panel 800. Similarly, in the touch panel 800 of the present embodiment, the capacitance value of the sensing lines 120, 130 can be inspected individually, so a good quality of the touch panel 800 can be achieved.

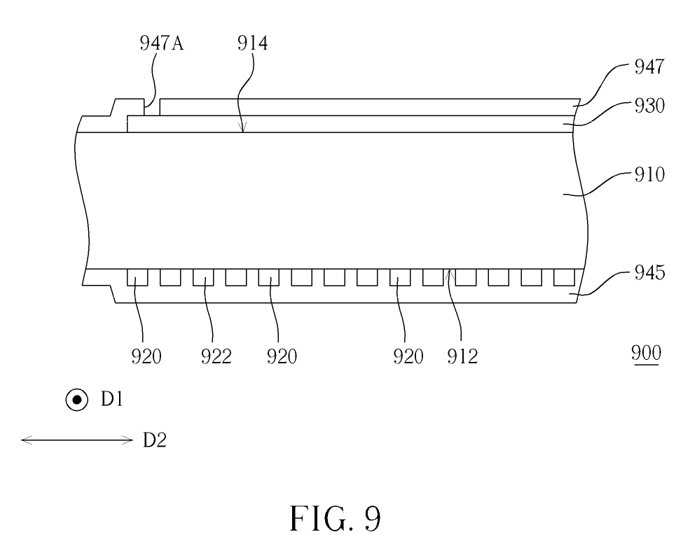

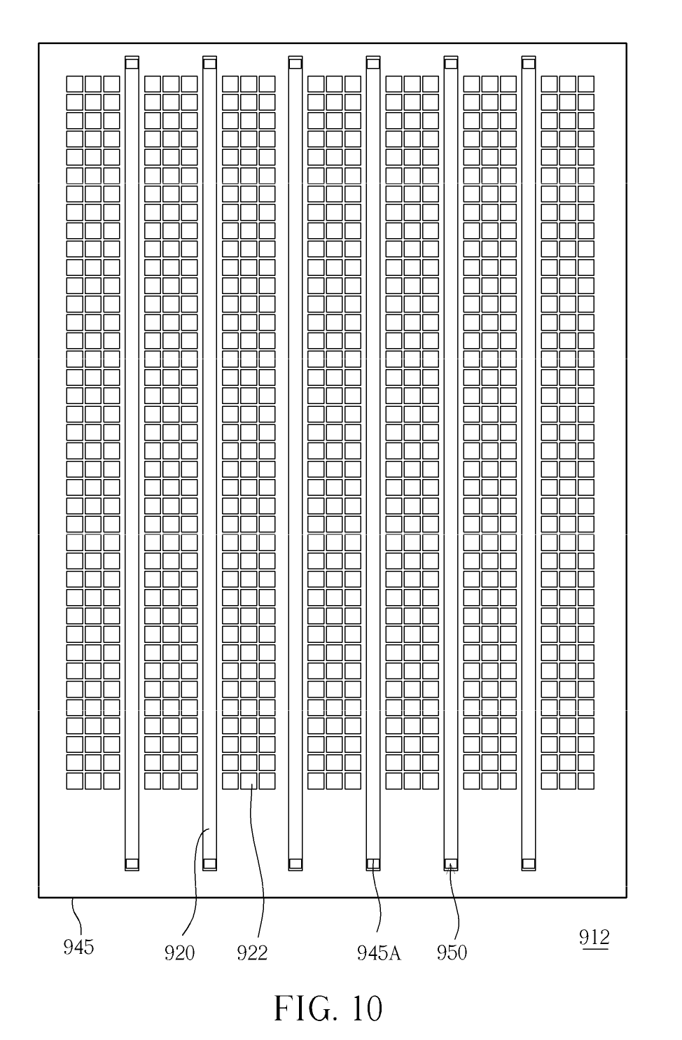

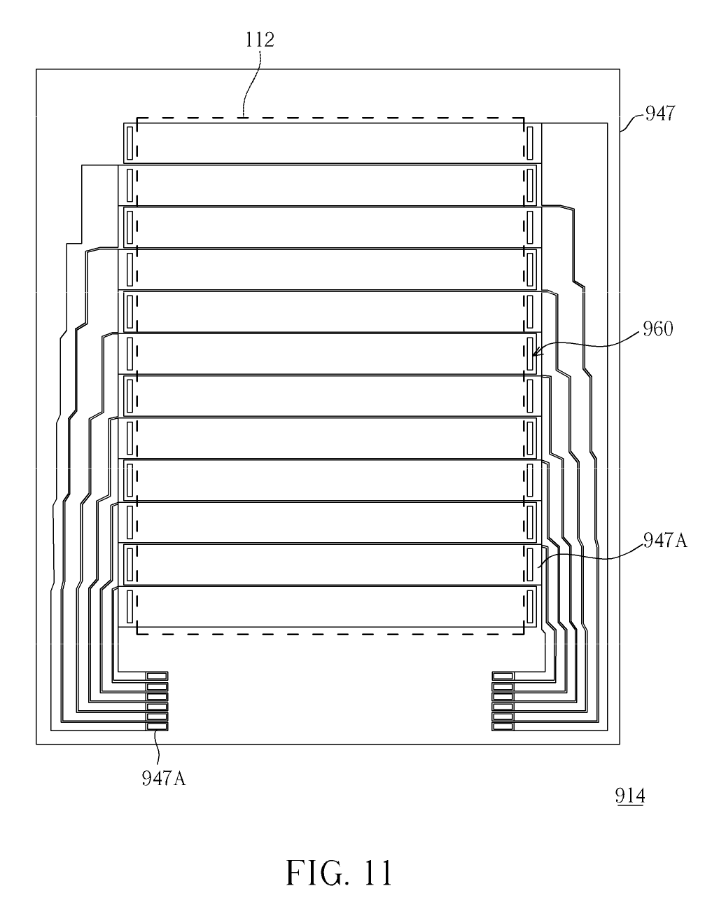

FIG. 9 is a schematic diagram showing a cross-sectional view of the fifth embodiment of the touch panel in the present invention. FIG. 10 is a schematic diagram showing a top view of the first side of the touch panel and FIG. 11 is a schematic diagram showing a top view of the second side of the touch panel. Please refer to FIG. 9. The touch panel 900 includes a substrate 910, a plurality of first sensing lines 920, a plurality of second sensing lines 930, a first insulation layer 945 and a second insulation layer 847. The first sensing lines 920 and the second sensing lines 930 are disposed on the substrate 910. In particular, the first sensing lines 920 are disposed on a first side 912 of the substrate 910, while the second sensing lines 930 are disposed on a second side 914 of the substrate 910. The first side 912 and second side 914 are disposed opposite to each other.

Please refer to FIG. 9, FIG. 10 and FIG. 11. Each first sensing line 920 extends along the first direction D1, and each second sensing line 930 extends along the second direction D2, where the first direction D1 and the second direction of D2 are not parallel. In addition, two first inspecting regions 950 are disposed respectively on two ends of the first sensing lines 920 and two second inspecting regions 960 are disposed respectively on two ends of the second sensing lines 930. The first insulation layer 945 covers the first sensing lines 920 and exposes the first inspecting regions 950. The second insulation layer 947 covers the second sensing lines 930 and exposes the second inspecting regions 960.

In detail, each first sensing line 920 is formed by a sensing bar and each second sensing line 930 is formed by a sensing bar. In other words, each first sensing line 920 and each second sensing line 930 are formed by a conductive bar-type pattern which includes, for example, transparent conductive material. Besides, in order to improve the uniformity of brightness of the touch panel 900, the touch panel 900 further includes a plurality of dummy pads 922 disposed on the first side 912 of the substrate 910 and is located between the first sensing lines 920.

In the present embodiment, the first insulation layer 945 includes a plurality of first openings 945A to expose the first inspecting regions 950. The second insulation layer 947 includes a plurality of second openings 947A to expose the second inspecting regions 960. Particularly, all the second openings 947A are disposed outside the display region 112. In another embodiment, the first openings 945A in the same side can be linked together and the second openings 947A in the same side can also be linked together. The first openings 945A and the second openings 947A expose their corresponding first inspecting regions 950 and their corresponding second inspecting regions 960, so the first sensing lines 920 and the second sensing lines 930 can be inspected separately. Therefore, the defects of the touch panel 900 can be detected correctly, being able to maintain the quality of the touch panel 900.

In addition, in the present embodiment, the first inspecting regions 950 are disposed on both ends of each first sensing line 920, and the second inspecting regions 960 are disposed on both ends of each second sensing line 930. However, according to different inspecting requirements and different layout designs, the first inspecting regions 950 are disposed on only one end of each first sensing line 920, and the second inspecting regions 960 are disposed on only one end of each second sensing line 930.

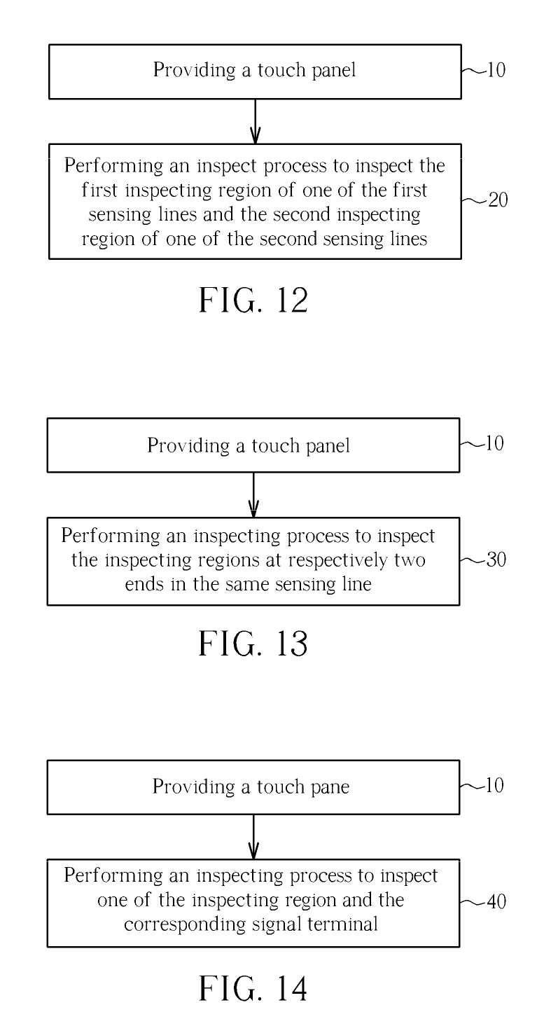

The touch panels 100, 400, 700, 800 and 900 described in the above mentioned embodiments respectively provide the inspecting regions on the end of each sensing line. These inspecting regions are exposed by the insulation layer. Therefore, a simple inspection method can be used for the touch panels 100, 400, 700, 800 and 900 to respectively detect whether there are defects between each sensing line or each connecting wire. Specifically, the inspection methods that can be used for the touch panels 100, 400, 700, 800 and 900 are shown as follows. FIG. 12 shows a first inspection method of one embodiment of the touch panel in the present invention. Please refer to FIG. 12. Step 10 is carried out firstly by providing a touch panel. In the inspection method of the present embodiment, the touch panel includes, for example, one of the aforementioned touch panels 100, 400, 700, 800 and 900 or one of the touch panels 100, 400, 700, 800 and 900 whose inspecting regions are disposed only on one end of each sensing line.

Then, step 20 is carried out to perform an inspecting process to inspect the first inspecting region of one of the first sensing lines and the second inspecting region of one of the second sensing lines. Specifically, the inspection process includes, for example, using a probe to respectively contact the first inspecting region of one of the first sensing lines and to contact the second inspecting region of one of the second sensing lines. Next, the capacitance value between the set of probes is measured. Then it is determined whether there is a short circuit or an open circuit on the first sensing lines or the second sensing lines according to the measured capacitance values.

In addition, when the patterns of the first sensing lines or the patterns of the second sensing lines are inconsistent due to some manufacturing process errors, for example, the size differences between the patterns are too large or the space between each patterns are inconsistent, these errors will change the capacitive coupling effect of the first sensing lines and the second sensing lines at different locations, leading to inaccurate measurements of the touch panel. The present embodiment can detect whether there are defects of the patterns of the sensing lines according to the change of the capacitance values between different sensing lines, and further fix the defects so as to enhance the sensing accuracy of the touch panel.

The inspection methods of the present embodiment can directly detect the capacitance value between different sensing lines when accompanying with the layout arrangement of the touch panels 100, 400, 700, 800 and 900. The inspection method is not affected by the connecting wires so the defects of the sensing lines can be detected more directly. That is, the defects of the sensing lines can be detected correctly and efficiently.

FIG. 13 shows a second inspection method of one embodiment of the touch panel in the present invention. Please refer to FIG. 13. The inspection method of a touch panel in the present embodiment includes, for example, performing step 10 by providing a touch panel. In this embodiment, the touch panel includes, for example, one of the aforementioned touch panels 100, 400, 700, 800 and 900. It is noted that, in the touch panel for the inspection method in the present embodiment, both ends of the sensing lines include the inspecting regions.

Then, step 30 is carried out by performing an inspecting process to inspect the inspecting regions at respectively two ends in one sensing line. By inspecting the resistance value of one sensing line through the inspecting regions on both ends of the sensing line, a short circuit or an open circuit defect of each sensing line can be detected. Moreover, if the difference of the connecting impedance of the sensing lines is too large, it can also be detected in step 30.

For example, when the method is applied to the touch panel 100, the probe can simultaneously contact the first inspecting regions 150 on both ends in the same first sensing line 120. Of course, the probe can also simultaneously access the second inspecting regions 160 on both ends in the same second sensing line 130. In such an inspecting process, the resistance value error in one of the sensing lines can be detected correctly and the corresponding repair work can be carried out. Thus, the quality of the touch panel can be improved by using such inspection method.

The aforementioned two kinds of inspection methods can effectively detect the defects within the sensing lines, but the electrical characteristics of the connecting wires in the touch panel should also be maintained to provide normal touch panel sensing function. Therefore, the present embodiment provides the following inspection method which is directed to inspect the connecting wires in the touch panel. FIG. 14 shows a third inspection method of one embodiment of the touch panel in the present invention. Please refer to FIG. 14. In the inspection method of the present embodiment, step 10 is carried out firstly by providing a touch panel. The touch panel includes one of the aforementioned touch panels 100, 400, 700, 800 and 900. It is noted that, in the touch panels used in this inspection method, the insulation layer exposes the signal terminals of the connecting wires. In addition, the inspecting region could be disposed only on the end of each sensing line that connects to the signal line.

Then, step 40 is carried out by performing an inspecting process to inspect one of the inspecting region and the corresponding signal terminal. For example, when the inspection method is applied to the touch panel 100, the step 40, for example, uses a probe to contact one of the first inspecting region 150 or the second inspecting region 160, and uses another probe to contact the corresponding first signal terminal S1b or the corresponding second terminal 52b. In this way, by using two probes to inspect the electrical characteristics of the first connecting wire S1 or the second connecting wire S2, the defects of the first connecting wire S1 or the second connecting wire S2 could be repaired. Certainly, the inspecting method can also be applied to the touch panels 400, 700, 800 and 900 so as to improve the quality of the touch panels 400, 700, 800 and 900.

In light of above, the inspecting regions in the present invention are disposed on the ends of each sensing line, and the insulation layer exposes the inspecting regions. Therefore, the present invention can directly detect whether there are defects in the sensing lines, and the connecting wires and the sensing lines can be inspected separately. The inspection methods of the touch panel are therefore more efficient. When the defects of the touch panel are detected, they can further be repaired. Accordingly, the touch panel in the present invention can have good quality.

Those skilled in the art will readily observe that numerous modifications and alterations of the device and method may be made while retaining the teachings of the invention.

What is claimed is:

1. A touch panel comprises:
a substrate;
a plurality of first sensing lines disposed on the substrate, wherein each first sensing line extends along a first direction and at least one end of each first sensing line comprises a first inspecting region;
a plurality of first connecting wires, wherein a connecting terminal of each first connecting wire connects to each first sensing line respectively;
a plurality of second sensing lines disposed on the substrate, wherein at least one end of each second sensing line comprises a second inspecting region and each second sensing line extends along a second direction, wherein the first direction is not parallel to the second direction;
a plurality of second connecting wires, wherein a connecting terminal of each second connecting wire connects to each second sensing line respectively; and
an insulation layer covering the first sensing lines and the second sensing lines and exposing the first inspecting regions and the second inspecting regions.

2. The touch panel as in claim 1, wherein the first sensing lines are perpendicular to the second sensing lines.

3. The touch panel as in claim 1, wherein the insulation layer comprises a plurality of openings disposed on exposed locations of the insulation layer, and the openings correspondingly expose the first inspecting regions and the second inspecting regions.

4. The touch panel as in claim 1, wherein an opening of the insulation layer exposing the first inspecting regions and the second inspecting regions has a circular shape.

5. The touch panel as in claim 1, wherein the each first sensing line comprises a plurality of sensing pads and a plurality of bridge parts, and each second sensing line comprises a plurality of sensing pads and a plurality of bridge parts.

6. The touch panel as in claim 5, wherein the sensing pads comprise a plurality of center sensing pads and two peripheral sensing pads, the center sensing pads are connected to each other by the bridge parts and are disposed between the two peripheral sensing pads, and the first inspecting region or the second inspecting region is disposed in the two peripheral sensing pads.

7. The touch panel as in claim 6, wherein the substrate comprises a display region and a non-display region, and each peripheral sensing pad comprises an outer part and an inner part, wherein the outer part is disposed in the non-display region, the inner part and the center sensing pads are disposed in the display region, and the first inspecting region or the second inspecting region is in the outer part.

8. The touch panel as in claim 1, wherein the substrate comprises a first sensing region and a second sensing region, and the insulation layer covering the first sensing region and the second sensing region exposes the first inspecting regions of the first sensing lines and the second inspecting regions of the second sensing lines.

9. The touch panel as in claim 1, wherein the first sensing lines are disposed on a first side of the substrate and the second sensing lines are disposed on a second side of the substrate, and the first side and the second side are disposed opposite to each other.

10. The touch panel as in claim 9, wherein the insulation layer comprises a first insulation layer and a second insulation layer, wherein the first insulation layer covers the first sensing lines and exposes the first inspecting regions, and the second insulation layer covers the second sensing lines and exposes the second inspecting regions.

11. The touch panel as in claim 10, wherein the first insulation layer comprises a plurality of first openings disposed on exposed locations of the first insulation layer, and the first openings correspondingly expose the first inspecting regions, and wherein the second insulation layer comprises a plurality of second openings disposed on exposed locations of the second insulation layer, and the second openings correspondingly expose the second inspecting regions.

12. The touch panel as in claim 1, wherein the insulation layer further covers the first connecting wires and second connecting wires and exposes a signal terminal of each first connecting wire and a signal terminal of each second connecting wire.

13. An inspection method of a touch panel, wherein the inspection method of the touch panel comprises:
providing a touch panel as in claim 1; and
performing an inspecting process to inspect two inspecting regions selected from the first inspecting regions and the second inspecting regions.

14. The inspection method of a touch panel as in claim 13, wherein two ends of each first sensing line comprise the first inspecting regions, and the inspecting process comprises inspecting the two first inspecting regions on the two ends of the same first sensing line.

15. The inspection method of a touch panel as in claim 13, wherein two ends of each second sensing line comprise the second inspecting regions, and the inspecting process comprises inspecting the two second inspecting regions on the two ends of the same second sensing line.

16. An inspection method of a touch panel, wherein the inspection method of the touch panel comprises:
providing the touch panel as in claim 12; and
performing an inspecting process to inspect one of the first inspecting regions and the corresponding signal terminal, or to inspect one of the second inspecting regions and the corresponding signal terminal.
